(19) United States
(12) Patent Application Publication
(10) Pub. No.: US 2007/0214051 A1
(43) Pub. Date: Sep. 13, 2007

(54) Release note/advertisement print out after firmware upgrade

(76) Inventors: Steven M. Johnson, Eagle, ID (US); William Mark Smith, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/801,753

(22) Filed: May 8, 2007

Related U.S. Application Data
(63) Continuation of application No. 09/949,250, filed on Sep. 7, 2001.

(51) Int. Cl. G06Q 30/00; G06Q 90/00

(52) U.S. Cl. 705/14

(57) ABSTRACT

This invention relates to a method for printing out release notes/advertisements after the firmware in the printer or other such firmware-containing devices have been upgraded. Such methods of this type, generally, provide the printer user with release notes which detail how the printer was upgraded and/or provide the user with advertisements, such as, but not limited to, promotions, coupons, rebates, product releases or the like.

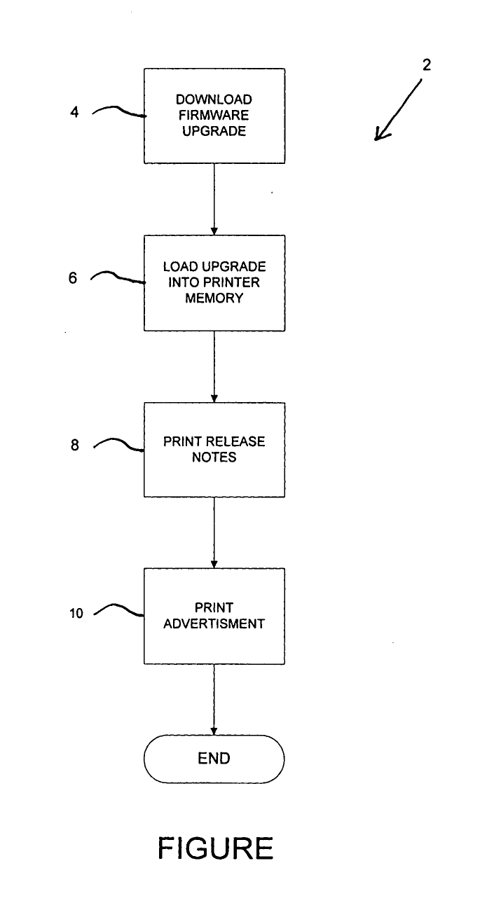

### FIELD OF THE INVENTION

This invention relates to a method for printing out release notes/advertisements after the firmware in the printer or other such firmware-containing devices have been upgraded. Such methods of this type, generally, provide the printer user with release notes which detail how the printer was upgraded and/or provide the user with advertisements, such as, but not limited to, promotions, coupons, rebates, product releases or the like.

### DESCRIPTION OF THE RELATED ART

Prior to the present invention, as set forth in general terms above and more specifically below, it is known to employ coupon printers. Exemplary of such prior art are U.S. Pat. No. 5,578,797 ('797) to R. C. W. Hewitt et al., entitled “Method and Apparatus for Printing Merchandising Information” and U.S. Pat. No. 6,151,587 ('587) to J. T. Matthias, entitled “Coupon Dispenser and Method for Generating Coupons.” While the '797 and '587 references teach the printing of coupons, a more advantageous method, then, would be employed if the coupons or other similar advertisements would be printed when the firmware in the printer was upgraded.

It is also known, in the firmware art, to upgrade the firmware. Exemplary of such prior art are commonly assigned U.S. Pat. No. 5,566,335 ('335) to M. Nash et al., entitled “Method and Apparatus for Firmware Upgrades in Embedded Systems,” commonly assigned U.S. Pat. No. 5,568,641 ('641) to M. D. Nelson et al., entitled “Powerfail Durable Flash EEPROM Upgrade,” U.S. Pat. No. 5,781,921 ('921) to R. A. Nichols, entitled “Method and Apparatus to Effect Firmware Upgrades Using a Removal Memory Device Under Software Control,” U.S. Pat. No. 6,031,867 ('867) to G. Johnson et al., entitled “Modem with Firmware Upgrade Feature” and U.S. Pat. No. 6,198,946 ('946) to S. Shin et al., entitled “Firmware Upgrade Method for Wireless Communications Device, and Method for Supporting Firmware Upgrade by Base Station.” While these references discuss various methods for upgrading firmware, they do not teach the use of providing the user with release notes or advertising when the firmware is upgraded.

It is apparent from the above that there exists a need in the art for a method which allows the firmware of the firmware-containing device, such as a computing device, a printing device or the like, to be upgraded, but which at the same time provides the user with firmware upgrade release notes and advertisements. It is a purpose of this invention to fulfill this and other needs in the art in a manner more apparent to the skilled artisan once given the following disclosure.

### SUMMARY OF THE INVENTION

Generally speaking, this invention fulfills these needs by providing a method for printing release notes/advertisements after a firmware upgrade, comprising the steps of: downloading a firmware upgrade; loading the upgrade into a firmware-containing device; printing a release note; and printing an advertisement.

In certain preferred embodiments, the firmware upgrade is downloaded from the Internet or a server. Also, the firmware-containing device can be, but is not limited to, a computing device, a printing device or the like. Finally, the advertisement can be, but is not limited to, promotions, coupons, rebates, product releases or the like.

In another further preferred embodiment, the method allows for the printing of release notes which detail how the firmware-containing device was upgraded and the printing of advertisements that provide the user with valuable product information about the firmware-containing device or other devices.

The preferred firmware upgrade method, according to this invention, offers the following advantages: release note printing; advertisement printing; firmware upgrade; and good economy. In fact, in many of the preferred embodiments these factors of release note printing, advertisement printing, and firmware upgrade are optimized to an extent that is considerably higher than heretofore achieved in prior, known firmware upgrade methods.

The above and other features of the present invention, which will become more apparent that the description proceeds, are best understood by considering the following detailed description in conjunction with the accompanying drawing FIGURE and in which:

### BRIEF DESCRIPTION OF THE DRAWING

The FIGURE is a flowchart that illustrates a method for printing release notes/advertisements after a firmware upgrade, according to one embodiment of the present invention.

### DETAILED DESCRIPTION OF THE INVENTION

With reference to the FIGURE, there is illustrated one preferred embodiment for use of the concepts of this invention. Method 2 for printing release notes/advertisements after a firmware upgrade is illustrated. Method 2, preferably, includes the steps of: downloading the firmware upgrade (step 4); loading the firmware upgrade into a firmware-containing device (step 6); printing a release note (step 8); and printing an advertisement (step 10).

With respect to step 4, the firmware can be conventionally downloaded from the Internet. Also, the firmware can be conventionally downloaded from a server. The firmware upgrade will be used to upgrade some or all of the firmware located in the firmware-containing device.

With respect to step 6, the firmware can be conventionally installed into the firmware-containing device. It is to be understood that the phrase “firmware-containing device” can refer to, but is not limited to, a computing device, a printing device or the like.

With respect to step 8, the release note can be conventionally printed. It is to be understood that the phrase “release note” refers to a notification to the user that some or all of the firmware located within the firmware-containing device has been upgraded. In this manner, the release note can provide details to the user on why the firmware was upgraded, how the firmware was upgraded when the firmware was upgraded, what firmware was upgraded, and how the firmware-containing device will operate based upon the firmware upgrade.

With respect to step 10, the advertisement can be conventionally printed. It is to the understood that the term “advertisement” can refer to, but is not limited to, promotions, coupons, rebates, product releases or the like. In this manner, the user is provided with valuable product information regarding the user's firmware-containing device and/or other devices the user may be interested in obtaining. Also, it is to be understood that individualized advertising could be printed such that the advertising is based, for example, upon the configuration detected at the upgrade, i.e, if the network card is slow or a third party print network card has been inserted into the printer.

Once given the above disclosure, many other features, modifications or improvements will become apparent to the skilled artisan. Such features, modifications or improvements are, therefore, considered to be a part of this invention, the scope of which is to be determined by the following claims.

1. A method for printing release notes/advertisements after a firmware upgrade, comprising the steps of:
downloading a firmware upgrade;
loading the upgrade into a firmware-containing device;
printing a release note after the firmware upgrade, such that the release note further comprises information on how the firmware-containing device was upgraded; and
printing an advertisement.

2. The method, as in claim 1, wherein the downloading step is further comprised of the step of:
downloading the firmware upgrade from the Internet.

3. The method, as in claim 1, wherein the downloading step is further comprised of the step of:
downloading the firmware upgrade from a server.

4. The method, as in claim 1, wherein the loading step is further comprised of the step of:
installing the upgrade into the firmware-containing device.

5. (canceled)

6. The method, as in claim 1, wherein the release note is further comprised of:
information on why the firmware-containing device was upgraded.

7. The method, as in claim 1, wherein the release note is further comprised of:
information on where the firmware-containing device was upgraded.

8. The method, as in claim 1, wherein the release note is further comprised of:
information on when the firmware-containing device was upgraded.

9. The method, as claim 1, wherein the advertisement is further comprised of:
a coupon.

10. The method, as in claim 1, wherein the advertisement is further comprised of:
a rebate.

11. The method, as in claim 1, wherein the advertisement is further comprised of:
a promotion.

12. The method, as in claim 1, wherein the advertisement is further comprised of:
a product release.

13. A program storage medium readable by a computer tangibly embodying a program of instructions executable by the computer to perform method steps for printing release notes/advertisements after a firmware upgrade, the method comprising the steps of:
downloading a firmware upgrade;
loading the upgrade into a firmware-containing device;
printing a release note after the firmware upgrade, such that the release note further comprises information on how the firmware-containing device was upgraded; and
printing an advertisement.

14. The method, as in claim 13, wherein the downloading step is further comprised of the step of:
downloading the firmware upgrade from the Internet.

15. The method, as in claim 13, wherein the downloading step is further comprised of the step of:
downloading the firmware upgrade from a server.

16. The method, as in claim 13, wherein the loading step is further comprised of the step of:
installing the upgrade into the firmware-containing device.

17. (canceled)

18. The method, as claim 13, wherein the advertisement is further comprised of:
a coupon.

19. The method, as in claim 13, wherein the advertisement is further comprised of:
a rebate.

20. The method, as in claim 13, wherein the advertisement is further comprised of:
a product release.

21. The method, as in claim 13, wherein the release note is further comprised of:
information on why the firmware-containing device was upgraded.

22. The method, as in claim 13, wherein the release note is further comprised of:
information on where the firmware-containing device was upgraded.

23. The method, as in claim 13, wherein the release note is further comprised of:
information on when the firmware-containing device was upgraded.
